(19) United States
(12) Patent Application Publication
(10) Pub. No.: US 2025/0013040 A1
(43) Pub. Date: Jan. 9, 2025

(54) IMAGE GENERATION APPARATUS AND HEAD-UP DISPLAY

(71) Applicant: KOITO MANUFACTURING CO., LTD., Tokyo (JP)

(72) Inventor: Noriko Sato, Shizuoka-shi (JP)

(73) Assignee: KOITO MANUFACTURING CO., LTD., Tokyo (JP)

(21) Appl. No.: 18/709,725

(22) PCT Filed: Nov. 7, 2022
(86) PCT No.: PCT/JP2022/041366

§ 371 Date: May 13, 2024

(30) Foreign Application Priority Data
Nov. 12, 2021 (JP) 2021-184654

(51) Int. Cl. G02B 27/01; B60K 35/23

(52) U.S. Cl. CPC G02B 27/0101; B60K 35/23; B60K 2360/23

(57) ABSTRACT

An image generation apparatus for generating an image of a head-up display includes a plurality of light sources, an optical member configured to transmit light emitted from the plurality of light sources, and a liquid crystal unit configured to generate a predetermined image by the light emitted from the optical member. The optical member includes an incident surface configured to receive the light emitted from the plurality of light sources, and an emitting surface configured to emit the light received by the incident surface to the liquid crystal unit. The emitting surface is formed by a single curved surface.

### TECHNICAL FIELD

The present disclosure relates to an image generation apparatus and a head-up display including the image generation apparatus.

### BACKGROUND ART

In the future, it is expected that vehicles traveling in an autonomous driving mode and vehicles traveling in a manual driving mode coexist on a public road.

In a future autonomous driving society, it is expected that visual communication between a vehicle and a human becomes increasingly important. For example, it is expected that visual communication between a vehicle and an occupant of the vehicle becomes increasingly important. In this respect, the visual communication between the vehicle and the occupant can be achieved by using a head-up display (HUD). The head-up display can achieve so-called augmented reality (AR) by projecting an image or a video on a windshield or a combiner, and allowing the occupant to visually recognize the image while superimposing the image on a real space through the windshield or the combiner.

Patent Literatures 1 and 2 each disclose a display device including an optical system for displaying a stereoscopic virtual image as an example of a head-up display. The display device projects light within a field of view of a driver on a windshield or a combiner. A part of the projected light is transmitted through the windshield or the combiner, but the other part is reflected by the windshield or the combiner. The reflected light is directed towards eyes of the driver. The driver recognizes the reflected light entering the eyes as a virtual image seen as an image of an object on the opposite side (outer side of a vehicle) across the windshield or the combiner, with an actual object seen through the windshield or the combiner as a background.

### CITATION LIST

### Patent Literature

Patent Literature 1: JP2018-045103A
Patent Literature 2: JP2017-097074A

### SUMMARY OF INVENTION

### Technical Problem

However, in an existing head-up display, there is room for improvement in improving visibility of a virtual image (image).

An object of the present disclosure is to provide an image generation apparatus with improved visibility of a virtual image and a head-up display including the image generation apparatus.

### Solution to Problem

An image generation apparatus of the present disclosure is an image generation apparatus for generating an image of a head-up display, the image generation apparatus including:

a plurality of light sources:

an optical member configured to transmit light emitted from the plurality of light sources; and

a liquid crystal unit configured to generate a predetermined image by the light emitted from the optical member, in which

the optical member includes an incident surface configured to receive the light emitted from the plurality of light sources, and an emitting surface configured to emit the light received by the incident surface to the liquid crystal unit, and

the emitting surface is formed by a single curved surface.

In an image generation apparatus in the related art, a plurality of aspherical convex lenses are arranged in a left-right direction, and adjacent aspherical convex lenses are partially coupled to each other. In this case, light passing through a connecting portion of the aspherical convex lenses may be emitted in an unintended direction, and unevenness may occur in light distribution of light emitted from an optical member. According to the image generation apparatus of the present disclosure, since the emitting surface of the optical member is formed by the single curved surface, such unevenness can be reduced. As a result, visibility of a virtual image is improved.

An image generation apparatus of the present disclosure is an image generation apparatus for generating an image of a head-up display, the image generation apparatus including:

a plurality of light sources:

an optical member configured to transmit light emitted from the plurality of light sources; and

a liquid crystal unit configured to generate a predetermined image by the light emitted from the optical member, in which

the optical member includes an incident surface configured to receive the light emitted from the plurality of light sources, and an emitting surface configured to emit the light received by the incident surface to the liquid crystal unit,

the optical member is a single Fresnel lens,

in a plan view of the liquid crystal unit,

the plurality of light sources are arranged in parallel in a longitudinal direction of the liquid crystal unit, and include a first light source located at a center in the longitudinal direction and a second light source located away from the center, and

a position of the first light source is different from a position of the second light source in a short direction of the liquid crystal unit.

According to the image generation apparatus of the present disclosure, since the optical member is the single Fresnel lens, a thickness of the optical member can be reduced. Therefore, the image generation apparatus can be miniaturized. In addition, since the position of the first light source is different from the position of the second light source in the short direction of the liquid crystal unit, the liquid crystal unit can generate an emitting surface image as an original image of a virtual image in consideration of distortion caused by reflection of a concave mirror or a windshield in advance. Accordingly, visibility of the virtual image can be improved.

A head-up display of the present disclosure is a head-up display that is to be provided in a vehicle and is for displaying an image to an occupant of the vehicle, the head-up display including:

the above image generation apparatus; and

a reflecting mirror configured to reflect light emitted from the above image generation apparatus.

### Advantageous Effects of Invention

According to the present disclosure, it is possible to provide an image generation apparatus with improved visibility of a virtual image and a head-up display including the image generation apparatus.

### BRIEF DESCRIPTION OF DRAWINGS

FIG. 1 is a schematic diagram showing a configuration of a head-up display (HUD) according to an embodiment.

FIG. 2 is a diagram showing an example of an emitting surface image generated by an image generation apparatus of a HUD according to a comparative example.

FIG. 3 is a diagram when the emitting surface image shown in FIG. 2 is displayed as a virtual image.

FIG. 4 is a diagram showing an example of an emitting surface image generated by an image generation apparatus of the HUD according to the present embodiment.

FIG. 5 is a diagram showing a virtual image object recognized when the emitting surface image shown in FIG. 4 is reflected by a concave mirror.

FIG. 6 is a perspective view showing a configuration of an image generation apparatus according to a first embodiment included in the HUD of FIG. 1.

FIG. 7 is a cross-sectional view showing the configuration of the image generation apparatus shown in FIG. 6.

FIG. 8 is a schematic diagram showing an arrangement of a plurality of light sources in a plan view of a liquid crystal unit included in the image generation apparatus of FIG. 6.

FIG. 9 is a perspective view showing a configuration of an image generation apparatus according to a second embodiment.

FIG. 10 is a cross-sectional view showing the configuration of the image generation apparatus shown in FIG. 9.

FIG. 11 is a schematic diagram showing an arrangement of a plurality of light sources in a plan view of a liquid crystal unit included in the image generation apparatus shown in FIG. 9.

FIG. 12 is a perspective view showing a configuration of an image generation apparatus according to a third embodiment.

### DESCRIPTION OF EMBODIMENTS

Hereinafter, an embodiment of the present disclosure (hereinafter, referred to as the present embodiment) will be described with reference to the drawings. For convenience of description, dimensions of members shown in the drawings may be different from actual dimensions of the members.

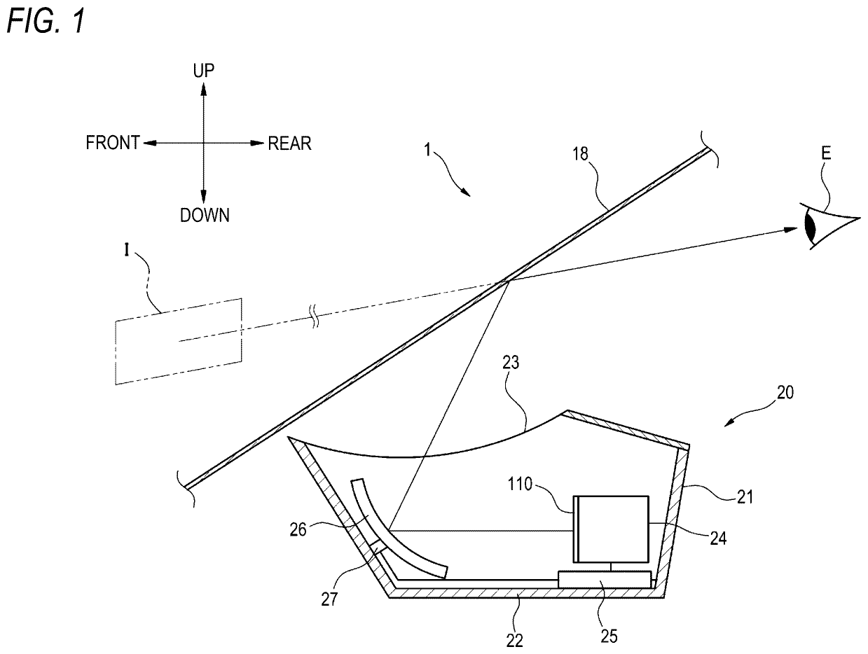

In the description of the present embodiment, for convenience of description, a “left-right direction”, an “up-down direction”, and a “front-rear direction” may be appropriately referred to. Each of these directions is a relative direction set for a head-up display (HUD) 20 shown in FIG. 1. Here, the “left-right direction” is a direction that includes a “left direction” and a “right direction”. The “up-down direction” is a direction that includes an “up direction” and a “down direction”. The “front-rear direction” is a direction that includes a “front direction” and a “rear direction”. Although not shown in FIG. 1, the left-right direction is a direction orthogonal to the up-down direction and the front-rear direction.

FIG. 1 is a schematic diagram of a HUD 20 provided in a vehicle 1 as viewed from a side surface side of the vehicle 1. At least a part of the HUD 20 is located inside the vehicle 1. Specifically, the HUD 20 is provided at a predetermined position inside a cabin of the vehicle 1. For example, the HUD 20 may be disposed inside a dashboard of the vehicle 1.

The HUD 20 displays predetermined information (hereinafter, referred to as HUD information) as an image to an occupant of the vehicle 1 such that the HUD information is superimposed on a real space outside the vehicle 1 (in particular, a surrounding environment in front of the vehicle 1). The HUD information displayed by the HUD 20 is, for example, vehicle traveling information on the traveling of the vehicle 1 and/or surrounding environment information on the surrounding environment of the vehicle 1 (in particular, information on an object present outside the vehicle 1). The HUD 20 is an AR display that functions as a visual interface between the vehicle 1 and the occupant.

The HUD 20 includes an image generation apparatus (PGU) 24, a control unit 25, and a concave mirror 26.

The image generation apparatus 24 emits light for generating a predetermined image to be displayed to the occupant of the vehicle 1. The image generation apparatus 24 can emit, for example, light for generating a change image that changes according to a situation of the vehicle 1.

The control unit 25 controls operations of the parts of the HUD 20. The control unit 25 is connected to a vehicle control unit, generates a control signal for controlling an operation of the image generation apparatus 24 based on, for example, the vehicle traveling information, the surrounding environment information, and the like transmitted from the vehicle control unit, and transmits the generated control signal to the image generation apparatus 24. The control unit 25 is mounted with a processor such as a CPU and a memory, and the processor executes a computer program read from the memory to control the operation of the image generation apparatus 24 and the like.

As shown in FIG. 1, the HUD 20 includes a HUD main body 21. The HUD main body 21 includes a main body housing 22 and an emitting window 23. The emitting window 23 is implemented by a transparent plate that transmits visible light. The HUD main body 21 accommodates the image generation apparatus 24, the control unit 25, and the concave mirror 26 inside the main body housing 22.

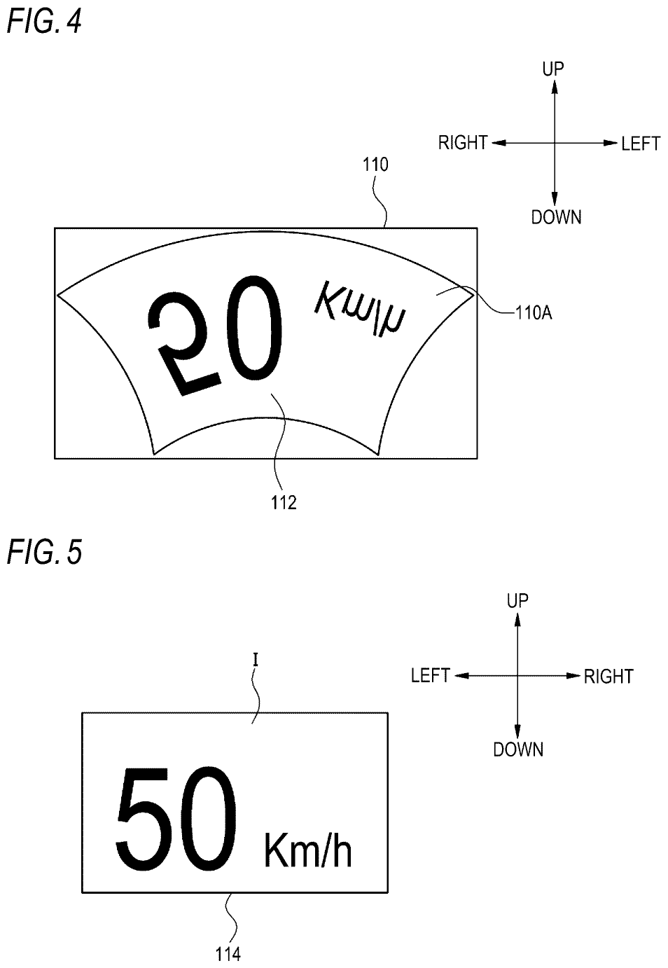

The image generation apparatus 24 is disposed in the main body housing 22 to face the front of the HUD 20. The image generation apparatus 24 includes a light emitting surface 110 that emits light for generating an image to the outside. The light emitting surface 110 is provided with a predetermined light emitting area 110A that emits light for generating a predetermined image to be displayed to the occupant of the vehicle 1. The predetermined light emitting area 110A will be described later with reference to FIG. 4.

The concave mirror 26 is disposed on an optical path of light emitted from the image generation apparatus 24. The concave mirror 26 reflects the light emitted from the image generation apparatus 24 to a windshield 18 (for example, a front window of the vehicle 1). The concave mirror 26 has a reflecting surface curved in a concave shape to form a predetermined image, and reflects an image formed by the light emitted from the image generation apparatus 24 at a predetermined magnification. The concave mirror 26 may include, for example, a drive mechanism 27, and may change a position and an orientation of the concave mirror 26 based on a control signal transmitted from the control unit 25. The concave mirror 26 is an example of a reflecting mirror.

The control unit 25 may generate a control signal for changing the position and the orientation of the concave mirror 26 and transmit the generated control signal to the drive mechanism 27.

The light emitted from the light emitting surface 110 of the image generation apparatus 24 is reflected by the concave mirror 26 and emitted from the emitting window 23 of the HUD main body 21. The light emitted from the emitting window 23 of the HUD main body 21 is radiated onto the windshield 18 which is a transmission member. A part of the light radiated from the emitting window 23 to the windshield 18 is reflected toward a viewpoint E of the occupant. As a result, the occupant recognizes the light emitted from the HUD main body 21 as a virtual image (predetermined image) formed in front of the windshield 18 at a predetermined distance. In this way, since the image displayed by the HUD 20 is superimposed on the real space in front of the vehicle 1 through the windshield 18, the occupant can visually recognize that a virtual image object I formed by the predetermined image floats on a road located outside the vehicle.

Here, the viewpoint E of the occupant may be either a viewpoint of the left eye or a viewpoint of the right eye of the occupant. Alternatively, the viewpoint E may be defined as a midpoint of a line segment connecting the viewpoint of the left eye and the viewpoint of the right eye. A position of the viewpoint E of the occupant is specified based on, for example, image data acquired by an internal camera of the vehicle 1. The position of the viewpoint E of the occupant may be updated at a predetermined period, or may be determined only once when the vehicle 1 is started.

When a 2D image (plane image) is formed as the virtual image object I, the predetermined image is projected to be a virtual image at any determined single distance. When a 3D image (stereoscopic image) is formed as the virtual image object I, a plurality of predetermined images that are the same or different from one another are projected to be virtual images at different distances. A distance of the virtual image object I (distance from the viewpoint E of the occupant to the virtual image) can be appropriately adjusted by adjusting a distance from the image generation apparatus 24 to the viewpoint E of the occupant (for example, by adjusting a distance between the image generation apparatus 24 and the concave mirror 26).

Since the light emitted from the light emitting surface 110 of the image generation apparatus 24 is reflected by the concave mirror 26, distortion occurs in the virtual image object I, which is recognized by the occupant as the predetermined image, due to the reflection of the concave mirror 26. Therefore, in order for the occupant to accurately recognize information on the virtual image object I, it is desirable, for example, to execute a correction process on the distortion of the virtual image object I that occurs.

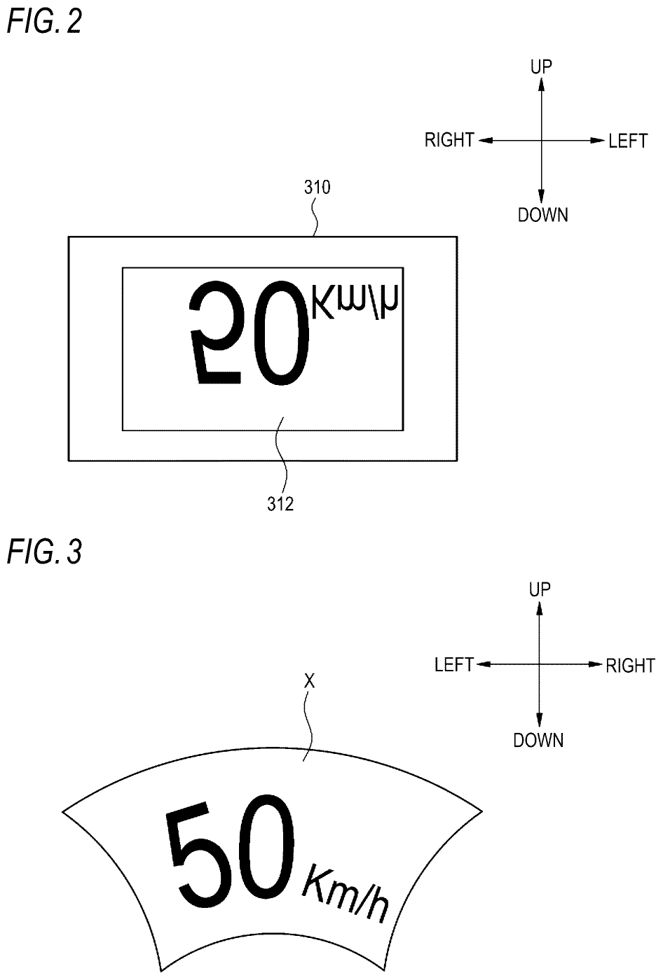

Next, the distortion occurring in the virtual image object and the process for correcting the distortion (correction by warping of the image) will be described with reference to FIGS. 2, 3, 4, and 5.

FIG. 2 shows an example of, in an image generated by light emitted from an image generation apparatus of a HUD according to a comparative example, an image on a light emitting surface 310 of the image generation apparatus, that is, an image generated by the light before being reflected by a concave mirror (hereinafter, also referred to as an emitting surface image) 312. FIG. 3 shows a virtual image object X recognized by the occupant as a predetermined image after the emitting surface image 312 shown in FIG. 2 is reflected by the concave mirror. In the image of this example, information indicating a traveling speed (50 km/h) of the vehicle 1 is displayed.

As shown in FIG. 2, in a case where the emitting surface image 312 on the light emitting surface 310 of the image generation apparatus according to the comparative example is a normal image, for example, an image in which a predetermined correction process is not executed on distortion caused by the reflection of the concave mirror, the virtual image object X generated by the light reflected by the concave mirror is displayed as an image having a distorted shape as shown in FIG. 3. In a case of this example, the virtual image object X is displayed as a curved image in which an upper side is extended and a lower side is contracted.

On the other hand, in the image generation apparatus 24 of the HUD 20 according to the present embodiment, in order to correct the distortion of the image caused by the reflection of the concave mirror 26, an inverse correction process (also referred to as a correction process by warping) is executed on an emitting surface image in advance.

FIG. 4 shows an example of an emitting surface image 112 generated by light emitted from the image generation apparatus 24 of the HUD 20. FIG. 5 shows the virtual image object I recognized by the occupant as a predetermined image after the emitting surface image 112 shown in FIG. 4 is reflected by the concave mirror 26.

As shown in FIG. 4, the light emitting surface 110 of the image generation apparatus 24 is formed in a rectangular shape, and is provided with the predetermined light emitting area 110A that emits the light for generating the predetermined image. In the predetermined light emitting area 110A, the emitting surface image 112 is generated by the light emitted from the predetermined light emitting area 110A. In the emitting surface image 112 of this example, similarly to the comparative example of FIGS. 2 and 3, a speed image notifying that a current traveling speed is 50 km/h is displayed.

The predetermined light emitting area 110A of the rectangular light emitting surface 110 is formed as, for example, an annular fan-shaped emitting area. The annular fan-shaped predetermined light emitting area 110A is an emitting area forming a rectangular display range 114 in which the virtual image object I shown in FIG. 5 is displayed. The predetermined light emitting area 110A is formed to occupy an area where the annular fan shape expands to a maximum extent on the light emitting surface 110, for example, in order to form the display range 114 to be large.

In this example, the correction process by warping is executed on the emitting surface image 112 of the predetermined light emitting area 110A. In order to correct the distortion caused by the reflection of the concave mirror 26, the emitting surface image 112 of the predetermined light emitting area 110A is subjected to a correction of extending an upper side of the image in advance by an amount of distortion due to the reflection of the concave mirror 26 and a correction of reducing a lower side of the image.

For example, as can be seen from the virtual image object X in FIG. 3, a degree of distortion that occurs in the virtual image object I due to the reflection of the concave mirror 26 decreases toward a central area of the virtual image object I, and increases toward end areas away from the central area. Therefore, an amount of correction by warping performed on the emitting surface image 112 as an original image of the virtual image object I varies depending on a position of the emitting surface image 112, corresponding to the degree of distortion depending on a portion of the virtual image object I. For example, an amount of correction of the emitting surface image in an area corresponding to a central portion of the virtual image object I is relatively small, and an amount of correction of the emitting surface image in an area corresponding to an end portion away from the central portion of the virtual image object I is relatively large.

As described above, the emitting surface image 112, which is the original image for forming the predetermined image, is formed into a shape that is subjected to the inverse correction process in which the emitting surface image 112 is distorted in advance in an inverse direction by the amount of distortion due to the reflection of the concave mirror 26. Therefore, when the light that generates the emitting surface image 112 is reflected by the concave mirror 26, as shown in FIG. 5, the virtual image object I is visually recognized having no distortion and having, for example, a horizontally long rectangular shape.

### First Embodiment

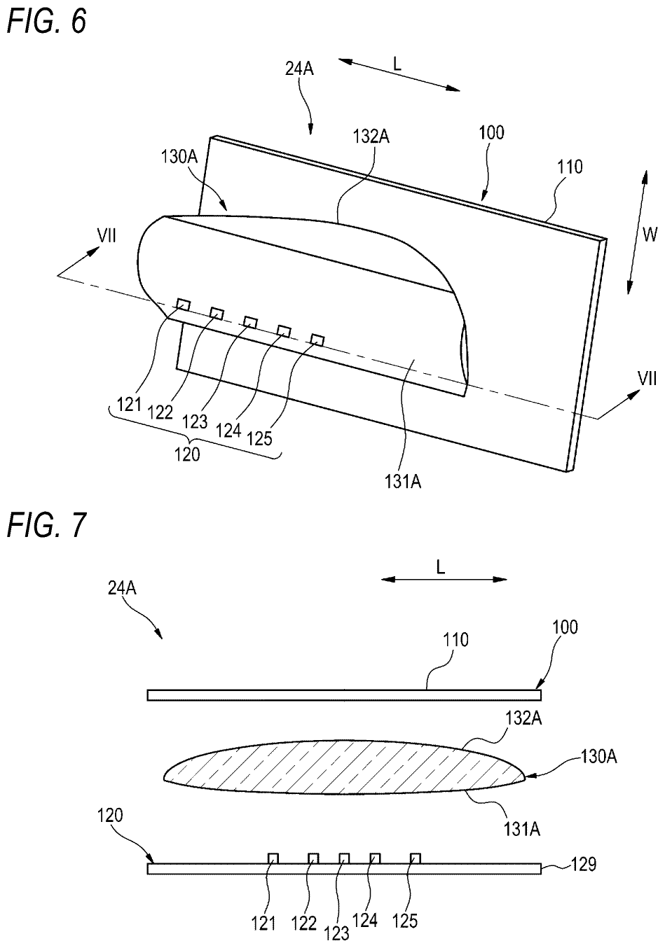

An image generation apparatus 24A according to a first embodiment will be described with reference to FIGS. 6 and 7.

FIG. 6 is a perspective view showing a configuration of the image generation apparatus 24A included in the HUD 20. FIG. 7 is a cross-sectional view of the image generation apparatus 24A shown in FIG. 6. As shown in FIGS. 6 and 7, the image generation apparatus 24A includes a plurality of light sources 120, a convex lens 130A, and a liquid crystal unit 100. The convex lens 130A is disposed between the plurality of light sources 120 and the liquid crystal unit 100. In FIG. 6, a substrate 129 of the plurality of light sources 120 is not shown in order to show an arrangement relationship among the light sources 120, the convex lenses 130A, and the liquid crystal unit 100.

The plurality of light sources 120 emits light toward the convex lens 130A. The plurality of light sources 120 of the present embodiment include light sources 121, 122, 123, 124, and 125. As shown in FIG. 7, the light sources 121, 122, 123, 124, and 125 are supported on the substrate 129. Each of the plurality of light sources 120 has the same configuration, and is, for example, a laser light source or an LED light source. In a case of a laser light source, each of the plurality of light sources 120 is an RGB laser light source that emits red laser light, green laser light, and blue laser light. The substrate 129 is, for example, a printed circuit board in which wiring of an electric circuit is printed on a surface of or inside a base substrate made of an insulator. Further, the plurality of light sources 120 are arranged in parallel in a longitudinal direction L of the liquid crystal unit 100 in a plan view of the liquid crystal unit 100. The arrangement of the plurality of light sources 120 will be described in detail later.

The convex lens 130A is a single convex lens, and transmits the light emitted from the plurality of light sources 120. The convex lens 130A includes an incident surface 131A that receives the light emitted from the plurality of light sources 120, and an emitting surface 132A that emits the light received by the incident surface 131A to the liquid crystal unit 100. The incident surface 131A is formed by a single convex curved surface. The emitting surface 132A is formed by a single convex curved surface. The convex lens 130A is an example of an optical member.

The liquid crystal unit 100 generates a predetermined image by the light emitted from the convex lens 130A. The liquid crystal unit 100 includes the light emitting surface 110 that emits the light emitted from the convex lens 130A to the outside of the image generation apparatus 24A (toward the concave mirror 26 in this example), and a drive circuit (not shown). The liquid crystal unit 100 has a rectangular shape. In the present embodiment, a direction along a long side of the liquid crystal unit 100 is defined as the longitudinal direction L, and a direction along a short side is defined as a short direction W. The liquid crystal unit 100 is controlled by the drive circuit to be in a state of transmitting the light from the convex lens 130A and a state of not transmitting the light for each pixel constituting a panel of the light emitting surface 110. By controlling transmission and blocking of the light for each pixel, light for generating a predetermined image is formed.

Next, an arrangement relationship of the plurality of light sources 120 will be described.

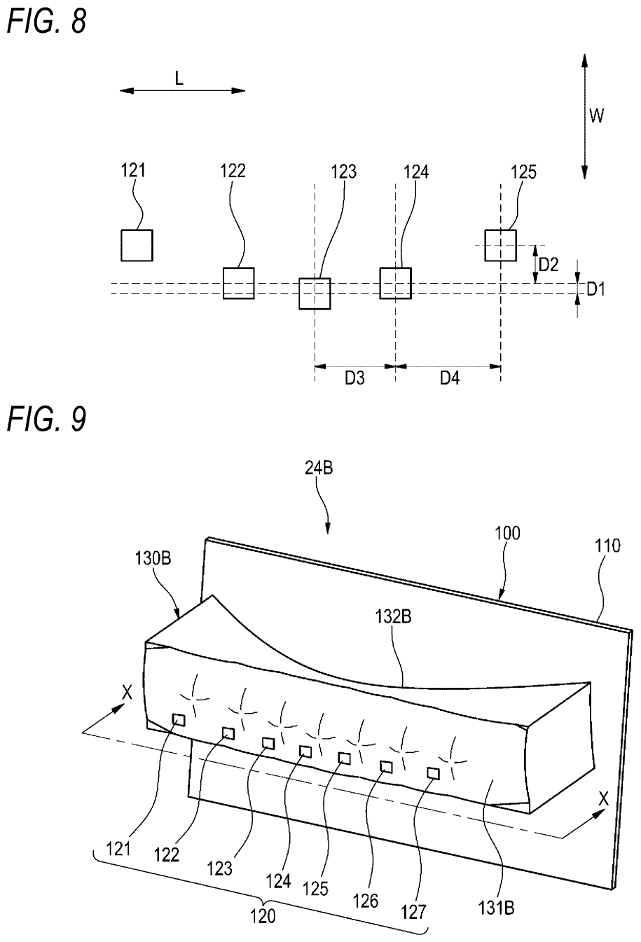

FIG. 8 is a schematic diagram showing the arrangement of the plurality of light sources 120 in the plan view of the liquid crystal unit 100. As shown in FIG. 8, the plurality of light sources 120 are arranged in parallel in the longitudinal direction of the liquid crystal unit 100. The light source 123 is located at a center in the longitudinal direction. The light sources 121, 122, 124, and 125 are located away from the center. The light source 122 is located on the left of the light source 123, and the light source 124 is located on the right of the light source 123. The light source 121 is located on the left of the light source 122, and the light source 125 is located on the right of the light source 124. In other words, the light source 122 is located between the light source 123 and the light source 121 in the longitudinal direction L of the liquid crystal unit 100. The light source 124 is located between the light source 123 and the light source 125 in the longitudinal direction L of the liquid crystal unit 100. The light source 123 is an example of a first light source. The light sources 121 and 125 are examples of a second light source. The light sources 122 and 124 are examples of a third light source.

In the present embodiment, a “position of a light source” means a position of a central portion of the light source. In addition, an “interval between light sources” means a length of a straight line connecting a central portion of one light source and a central portion of the other light source.

In the short direction W of the liquid crystal unit 100, a position of the light source 123 is different from a position of the light source 124, and the position of the light source 123 is different from a position of the light source 125. In the short direction W of the liquid crystal unit 100, a position of the light source 122 and the position of the light source 124 coincide with each other, and a position of the light source 121 and the position of the light source 125 coincide with each other.

In the present embodiment, in the short direction W of the liquid crystal unit 100, an interval D1 between the light source 123 and the light source 124 is shorter than an interval D2 between the light source 124 and the light source 125. In addition, in the longitudinal direction L of the liquid crystal unit 100, an interval D3 between the light source 123 and the light source 124 is shorter than an interval D4 between the light source 124 and the light source 125. For example, the plurality of light sources 120 are arranged such that the interval D4 is 1.05 times to 1.1 times the interval D3 or 0.5 mm longer.

Here, a configuration of an image generation apparatus in the related art and a HUD including the image generation apparatus will be described as a comparative example.

In the image generation apparatus in the related art, a plurality of aspherical convex lenses are arranged in a row, and adjacent aspherical convex lenses are partially coupled to each other. In this case, light passing through a connecting portion of the aspherical convex lenses may be emitted in an unintended direction, and unevenness may occur in light distribution of light emitted from an optical member.

When a HUD in the related art includes a concave mirror, distortion may occur in a virtual image due to reflection of the concave mirror. Even when the HUD does not include a concave mirror, distortion may occur in the virtual image due to reflection on a windshield, which is a light output destination. The distortion based on the reflection of the concave mirror or the windshield decreases toward a central area of the virtual image, and increases toward end areas away from the central area. In addition, the virtual image may not have an equal pitch due to a magnification of a lens.

According to the image generation apparatus 24A of the present embodiment, the emitting surface 132A of the convex lens 130A is formed by the single curved surface. Therefore, unevenness is less likely to occur in light distribution of the light emitted from the emitting surface 132A. As a result, visibility of a virtual image is improved. The HUD 20 including the image generation apparatus 24A also has the same effect. In addition, since the HUD 20 includes the concave mirror 26, the light from the image generation apparatus 24A can be further collected, and a bright virtual image can be displayed.

According to the image generation apparatus 24A of the present embodiment, the position of the light source 123 and the position of the light source 125 in the short direction W of the liquid crystal unit 100 are different. Therefore, the liquid crystal unit 100 can generate the emitting surface image 112, which is the original image of the virtual image, in consideration of distortion caused by the reflection of the concave mirror 26 or the windshield 18 in advance. In this way, since the image generation apparatus 24A can execute the correction process by warping on the emitting surface image 112, the visibility of the virtual image can be improved.

According to the image generation apparatus 24A of the present embodiment, the interval D1 between the light source 123 and the light source 124 is shorter than the interval D2 between the light source 125 and the light source 124 in the short direction W of the liquid crystal unit 100. Therefore, in the short direction W, an amount of correction of the emitting surface image 112 in an area corresponding to a central portion of the virtual image can be relatively small, and an amount of correction of the emitting surface image 112 in an area corresponding to an end portion away from the central portion of the virtual image can be relatively large. Thus, the image generation apparatus 24A of the present embodiment can correct the distortion caused by the reflection of the concave mirror 26 or the windshield 18 according to the area, and can improve the visibility of the virtual image.

According to the image generation apparatus 24A of the present embodiment, the interval D3 between the light source 123 and the light source 124 is shorter than the interval D4 between the light source 125 and the light source 124 in the longitudinal direction L of the liquid crystal unit 100. Therefore, in the longitudinal direction L, an amount of correction of the emitting surface image 112 in the area corresponding to the central portion of the virtual image can be relatively small, and an amount of correction of the emitting surface image 112 in the area corresponding to the end portion away from the central portion of the virtual image can be relatively large. The image generation apparatus 24A of the present embodiment can execute the correction process by warping on the emitting surface image 112 by adjusting the position of each of the plurality of light sources 120 for the distortion caused by the reflection of the concave mirror 26 or the windshield 18. As a result, the visibility of the virtual image can be improved.

According to the image generation apparatus 24A of the present embodiment, since the convex lens 130A is the single convex lens, the unevenness is less likely to occur in the light distribution of the emitted light as compared with a case where a plurality of aspherical lenses are integrally formed. Therefore, the visibility of the virtual image is improved.

In the present embodiment, in the short direction W, the positions of the plurality of light sources 121, 122, 124, and 125 are shifted in one direction (upward in FIG. 8) with respect to the position of the light source 123, but may be shifted in the other direction (downward in FIG. 8) according to an optical system of the HUD 20 or a specification of the vehicle 1.

### Second Embodiment

In the first embodiment, an example is shown in which the image generation apparatus 24A includes the single convex lens 130A as the optical member, but the optical member is not limited to a convex lens. The optical member may be a concave lens. In addition, the number of the plurality of light sources 120 is not limited to five.

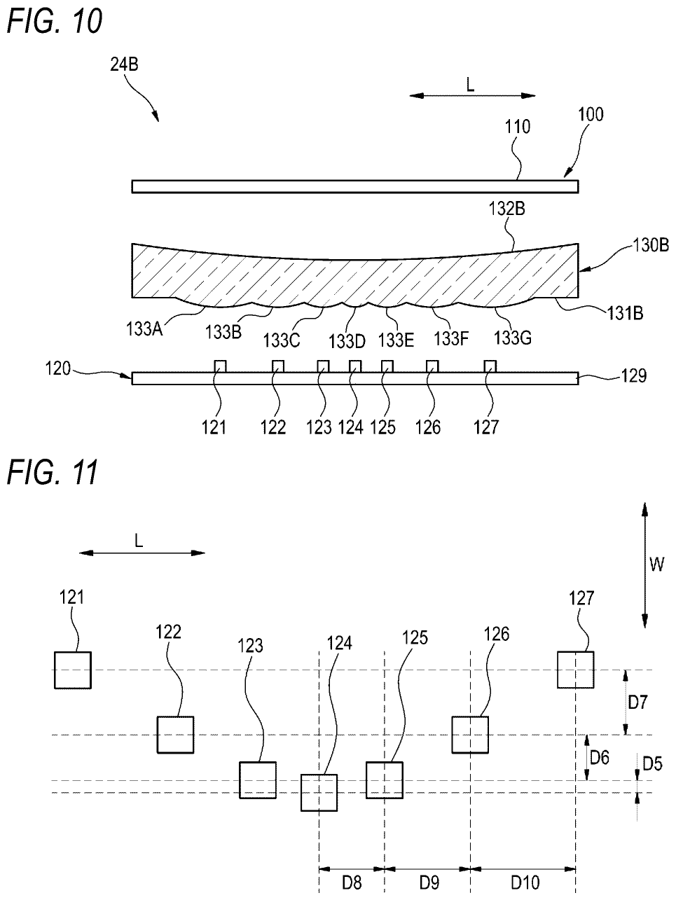

FIG. 9 is a perspective view showing a configuration of an image generation apparatus 24B according to a second embodiment. FIG. 10 is a cross-sectional view of the image generation apparatus 24B shown in FIG. 9. In the configuration shown in FIGS. 9 and 10, the same components as those shown in FIGS. 6 and 7 are denoted by the same reference numerals, and the description thereof is omitted.

As shown in FIGS. 9 and 10, the image generation apparatus 24B includes the plurality of light sources 120, a concave lens 130B, and the liquid crystal unit 100. The concave lens 130B is disposed between the plurality of light sources 120 and the liquid crystal unit 100.

The plurality of light sources 120 of the present embodiment include light sources 121, 122, 123, 124, 125, 126, and 127, and the substrate 129. As shown in FIG. 10, the light sources 121, 122, 123, 124, 125, 126, and 127 are supported on the substrate 129. Each of the plurality of light sources 120 has the same configuration, and is, for example, a laser light source or an LED light source. Further, the plurality of light sources 120 are arranged in parallel in the longitudinal direction L of the liquid crystal unit 100 in a plan view of the liquid crystal unit 100. The arrangement of the plurality of light sources 120 will be described in detail later.

The concave lens 130B is a single concave lens, and transmits light emitted from the plurality of light sources 120. The concave lens 130B includes an incident surface 131B that receives the light emitted from the plurality of light sources 120, and an emitting surface 132B that emits the light received by the incident surface 131B to the liquid crystal unit 100. The incident surface 131B has a plurality of curved surfaces 133A to 133G. Specifically, seven aspherical convex lenses facing the light source 121 to the light source 127, respectively, are arranged in parallel in a row, and adjacent aspherical convex lenses are partially connected to each other. The curved surface 133A faces the light source 121, and is an incident surface that is convex to the light source 121. The curved surface 133B faces the light source 122, and is an incident surface that is convex to the light source 122. The curved surface 133C faces the light source 123, and is an incident surface that is convex to the light source 123. The curved surface 133D faces the light source 124, and is an incident surface that is convex to the light source 124. The curved surface 133E faces the light source 125, and is an incident surface that is convex to the light source 125. The curved surface 133F faces the light source 126, and is an incident surface that is convex to the light source 126. The curved surface 133G faces the light source 127, and is an incident surface that is convex to the light source 127. The curved surfaces 133A to 133G are examples of a curved convex shape.

The emitting surface 132B of the concave lens 130B is formed by a single concave curved surface. The concave lens 130B is an example of the optical member.

Next, an arrangement relationship of the plurality of light sources 120 will be described.

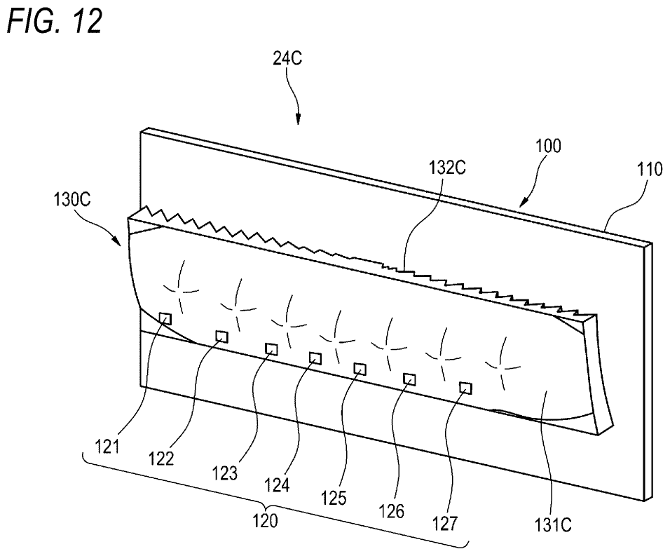

FIG. 11 is a schematic diagram showing the arrangement of the plurality of light sources 120 in the plan view of the liquid crystal unit 100. As shown in FIG. 11, the plurality of light sources 120 are arranged in parallel in the longitudinal direction of the liquid crystal unit 100. In the present embodiment, the light source 124 is located at a center in the longitudinal direction. The light sources 121, 122, 123, 125, 126, and 127 are located away from the center. The light source 123 is located on the left of the light source 124, and the light source 125 is located on the right of the light source 124. The light source 122 is located on the left of the light source 123, and the light source 126 is located on the right of the light source 125. The light source 121 is located on the left of the light source 122, and the light source 127 is located on the right of the light source 126. In the present embodiment, the light source 124 is an example of the first light source. The light sources 121 and 127 are examples of the second light source. The light sources 122, 123, 125, and 126 are examples of the third light source.

In the short direction W of the liquid crystal unit 100, a position of the light source 124 is different from a position of the light source 125, a position of the light source 126, and a position of the light source 127. In the short direction W of the liquid crystal unit 100, a position of the light source 123 and the position of the light source 125 coincide with each other. In the short direction W of the liquid crystal unit 100, a position of the light source 122 and the position of the light source 126 coincide with each other. In the short direction W of the liquid crystal unit 100, a position of the light source 121 and the position of the light source 127 coincide with each other.

In the present embodiment, in the short direction W of the liquid crystal unit 100, an interval D5 between the light source 124 and the light source 125 is shorter than an interval D6 between the light source 125 and the light source 126. In the short direction W of the liquid crystal unit 100, an interval D6 between the light source 125 and the light source 126 is shorter than an interval D7 between the light source 126 and the light source 127. In addition, in the longitudinal direction L of the liquid crystal unit 100, an interval D8 between the light source 124 and the light source 125 is shorter than an interval D9 between the light source 125 and the light source 126. In the longitudinal direction L of the liquid crystal unit 100, an interval D9 between the light source 125 and the light source 126 is shorter than an interval D10 between the light source 126 and the light source 127. For example, the plurality of light sources 120 are arranged such that the interval D9 is 1.1 times to 1.2 times the interval D8 or 1 mm longer and the interval D10 is 1.1 times to 1.2 times the interval D9 or 1 mm longer.

As described above, according to the image generation apparatus 24B of the present embodiment, the emitting surface 132B of the concave lens 130B is formed by the single curved surface. Therefore, unevenness is less likely to occur in light distribution of the light emitted from the emitting surface 132B. As a result, visibility of a virtual image is improved.

According to the image generation apparatus 24B of the present embodiment, since the concave lens 130B is the single concave lens, the unevenness is less likely to occur in the light distribution of the emitted light as compared with a case where a plurality of aspherical lenses are integrally formed. Therefore, the visibility of the virtual image is improved.

When the optical member is the single convex lens 130A, the emitted light is likely to spread in the longitudinal direction L of the liquid crystal unit 100, and there is room for improvement in utilization efficiency of the plurality of light sources 120. Further, the emitting surface image 112 in an area corresponding to light passing through a central portion of the convex lens 130A is relatively bright, and the emitting surface image 112 in an area corresponding to an end portion away from the central portion of the convex lens 130A is relatively dark. According to the image generation apparatus 24B of the present disclosure, since the optical member is the single concave lens 130B, as compared with a case where the optical member is the single convex lens 130A, the emitted light is less likely to spread in the longitudinal direction L of the liquid crystal unit 100, and the utilization efficiency of the plurality of light sources 120 can be improved. Further, as compared with the case where the optical member is the single convex lens 130A, it is possible to reduce a difference in brightness of the emitting surface image 112. Therefore, the visibility of the virtual image is further improved.

According to the image generation apparatus 24B of the present embodiment, the incident surface 131B has the plurality of curved surfaces 133A to 133G, and the plurality of curved surfaces 133A to 133G face the plurality of light sources 121 to 127, respectively. Therefore, the image generation apparatus 24B can efficiently collect the light emitted from each of the plurality of light sources 121 to 127, and can improve the utilization efficiency of the plurality of light sources 121 to 127. Further, since the emitting surface 132B of the concave lens 130B is formed by the single curved surface, the light collected from each of the plurality of light sources 121 to 127 can be emitted in a relatively uniform manner without unevenness.

In the present embodiment, in the short direction W, the positions of the plurality of light sources 121, 122, 123, 125, 126, and 127 are shifted in one direction (upward in FIG. 11) with respect to the position of the light source 124, but may be shifted in the other direction (downward in FIG. 11) according to an optical system of the HUD 20 or a specification of the vehicle 1.

### Third Embodiment

In the second embodiment, an example is shown in which the image generation apparatus 24B includes the single concave lens 130B as the optical member, but the optical member is not limited to a concave lens. The optical member may be a Fresnel lens.

FIG. 12 is a perspective view showing a configuration of an image generation apparatus 24C according to a third embodiment. In the configuration shown in FIG. 12, the same components as those shown in FIG. 9 are denoted by the same reference numerals, and the description thereof is omitted.

As shown in FIG. 12, the image generation apparatus 24C includes the plurality of light sources 120, a Fresnel lens 130C, and the liquid crystal unit 100. The Fresnel lens 130C is disposed between the plurality of light sources 120 and the liquid crystal unit 100.

The Fresnel lens 130C is a single Fresnel lens, and transmits light emitted from the plurality of light sources 120. The Fresnel lens 130C includes an incident surface 131C that receives the light emitted from the plurality of light sources 120, and an emitting surface 132C that emits the light received by the incident surface 131C to the liquid crystal unit 100. The incident surface 131C has the plurality of curved surfaces 133A to 133G. Specifically, seven aspherical convex lenses facing the light source 121 to the light source 127, respectively, are arranged in parallel in a row, and adjacent aspherical convex lenses are partially connected to each other.

The number and arrangement of the plurality of light sources 120 are the same as the number and arrangement of the plurality of light sources 120 in the second embodiment. That is, the plurality of light sources 120 are arranged in parallel in the longitudinal direction L of the liquid crystal unit 100, and include the light source 124 located at a center in the longitudinal direction L and the light source 127 located away from the center. In the short direction W of the liquid crystal unit 100, a position of the light source 124 is different from a position of the light source 127.

According to the image generation apparatus 24C of the present embodiment, since the Fresnel lens 130C is the single Fresnel lens, a thickness of the lens can be reduced. Therefore, the image generation apparatus 24C can be miniaturized. In addition, since the position of the light source 124 is different from the position of the light source 127 in the short direction W of the liquid crystal unit 100, the liquid crystal unit 100 can generate an emitting surface image as an original image of a virtual image in consideration of distortion caused by reflection of the concave mirror 26 or the windshield 18 in advance. Accordingly, visibility of the virtual image can be improved.

Although the embodiments of the present disclosure have been described above, it is needless to say that the technical scope of the present disclosure should not be construed as being limited by the description of the embodiments. The present embodiment is merely an example, and it is understood by those skilled in the art that various modifications of the embodiment are possible within the scope of the invention described in the claims. The technical scope of the present disclosure should be determined based on the scope of the invention described in the claims and the equivalent scope thereof.

The present application is based on the priority based on Japanese patent application No. 2021-184654 filed on Nov. 12, 2021, and all the contents described in the Japanese patent application are incorporated.

1. An image generation apparatus configured to generate an image of a head-up display, the image generation apparatus comprising:
a plurality of light sources;
an optical member configured to transmit light emitted from the plurality of light sources; and
a liquid crystal unit configured to generate a predetermined image by the light emitted from the optical member,
wherein the optical member includes an incident surface configured to receive the light emitted from the plurality of light sources, and an emitting surface configured to emit the light received by the incident surface to the liquid crystal unit, and
wherein the emitting surface is formed by a single curved surface.

2. The image generation apparatus according to claim 1,
wherein in a plan view of the liquid crystal unit,
wherein the plurality of light sources are arranged in parallel in a longitudinal direction of the liquid crystal unit, and include a first light source located at a center in the longitudinal direction and a second light source located away from the center, and
wherein a position of the first light source is different from a position of the second light source in a short direction of the liquid crystal unit.

3. The image generation apparatus according to claim 2,
wherein the plurality of light sources further include a third light source located between the first light source and the second light source in the longitudinal direction of the liquid crystal unit, and
wherein an interval between the first light source and the third light source is shorter than an interval between the second light source and the third light source in the short direction of the liquid crystal unit.

4. The image generation apparatus according to claim 2,
wherein the plurality of light sources further include a third light source located between the first light source and the second light source in the longitudinal direction of the liquid crystal unit, and
wherein an interval between the first light source and the third light source is shorter than an interval between the second light source and the third light source in the longitudinal direction of the liquid crystal unit.

5. The image generation apparatus according to claim 3, wherein the interval between the first light source and the third light source is shorter than the interval between the second light source and the third light source in the longitudinal direction of the liquid crystal unit.

6. The image generation apparatus according to claim 1, wherein the optical member is a single convex lens.

7. The image generation apparatus according to claim 1, wherein the optical member is a single concave lens.

8. The image generation apparatus according to claim 7,
wherein the incident surface has a plurality of curved convex shapes, and
wherein the curved convex shapes face the plurality of light sources, respectively.

9. An image generation apparatus configured to generate an image of a head-up display, the image generation apparatus comprising:
a plurality of light sources;
an optical member configured to transmit light emitted from the plurality of light sources; and
a liquid crystal unit configured to generate a predetermined image by the light emitted from the optical member,
wherein the optical member includes an incident surface configured to receive the light emitted from the plurality of light sources,
wherein an emitting surface configured to emit the light received by the incident surface to the liquid crystal unit,
wherein the optical member is a single Fresnel lens,
wherein in a plan view of the liquid crystal unit,
wherein the plurality of light sources are arranged in parallel in a longitudinal direction of the liquid crystal unit, and include a first light source located at a center in the longitudinal direction and a second light source located away from the center, and
wherein a position of the first light source is different from a position of the second light source in a short direction of the liquid crystal unit.

10. A head-up display that is to be provided in a vehicle and is configured to display an image to an occupant of the vehicle, the head-up display comprising:
an image generation apparatus configured to generate an image of a head-up display, the image generation apparatus comprising:
a plurality of light sources;
an optical member configured to transmit light emitted from the plurality of light sources; and
a liquid crystal unit configured to generate a predetermined image by the light emitted from the optical member,
wherein the optical member includes an incident surface configured to receive the light emitted from the plurality of light sources, and an emitting surface configured to emit the light received by the incident surface to the liquid crystal unit, and
wherein the emitting surface is formed by a single curved surface; and
a reflecting mirror configured to reflect light emitted from the image generation apparatus.

11. The head-up display according to claim 10, wherein the reflecting mirror is a concave mirror.
